(19) United States
(12) Patent Application Publication
(10) Pub. No.: US 2002/0198960 A1
(43) Pub. Date: Dec. 26, 2002

(54) Method and apparatus for providing a common text messaging system within a software architecture

(76) Inventors: Anne Robb, Casselberry, FL (US); John Gearhart, Lake Mary, FL (US)

Correspondence Address: Siemens Corporation, Intellectual Property Department, 186 Wood Avenue South, Iselin, NJ, 08830, US

(21) Appl. No.: 10/159,208

(22) Filed: May 30, 2002

Related U.S. Application Data
(60) Provisional application No. 60/294,201, filed on May 30, 2001.

(51) Int. Cl. G06F 15/16

(52) U.S. Cl. 709/217

(57) ABSTRACT

A method and system is disclosed for centralizing text message storage and processing in a computer controlled process system. The method minimizes the memory storage requirements overall and also minimizes the memory required to reference a text message within an inter-task message in a multi-tasked software operating system. A Text Reference Method (TRM) defines different formats to reference texts in a single word. These formats flexibly allow for several types of text message handling so that memory is optimized and processing overhead is minimized. The TRM permits partitioning of text databases by type but maintains a central management philosophy in order to reduce duplicate text messages and maintain consistency in text usage. A global standardized access method is presented for use by disparate tasks in a system.

### CROSS REFERENCE TO RELATED APPLICATIONS

This application claims the benefit of priority under 35 U.S.C. 119(e) to copending U.S. Patent Provisional Applications, Serial No. 60/294,201 and filed on May 30, 2001, the contents of said application being incorporated by reference herein in its entirely.

This application is also related to the following U.S. patent applications: U.S. patent application Ser. No. ______ filed May 30, 2002 entitled AN INTEGRATED ACCESS PLATFORM; U.S. patent application Ser. No. ______ filed May 30, 2002 entitled METHOD FOR OPERATING AND APPARATUS FOR A BACK-PLANE SUPPORTING REDUNDANT CIRCUIT CARDS; U.S. patent application Ser. No. ______ filed May 30, 2002 entitled METHOD AND APPARATUS OF TESTING A POTS CIRCUIT AND DSL CIRCUIT THROUGH A SPLITTER; U.S. patent application Ser. No. ______ filed May 30, 2002 entitled METHOD AND APPARATUS FOR LOADING A MIRROR IMAGE SOFTWARE COPY ACROSS CIRCUIT CARDS; U.S. patent application Ser. No. ______ filed May 30, 2002 entitled METHOD AND APPARATUS FOR A COMMON MANAGEMENT SOFTWARE SYSTEM; U.S. patent application Ser. No. ______ filed May 30, 2002 entitled METHOD AND APPARATUS FOR PROVIDING A STATE MACHINE OPERATING ON A REAL-TIME OPERATING SYSTEM; and U.S. patent application Ser. No. ______ filed May 30, 2002 entitled METHOD AND APPARATUS FOR ADMINISTERING MULTIPLE PROVISIONABLE OBJECTS, the contents of each of said applications being incorporated by reference herein in their entirely.

### DESCRIPTION

### BACKGROUND OF THE INVENTION

1. Field of the Invention

The present invention generally relates to a real-time software messaging system and method within a communications system. More specifically, message texts are centralized but are accessed and referred to in a global standardized manner by various functional tasks within the system.

2. Background Description

Various types of process control systems employing microprocessors and software to manage the functions of real time activities have been common in many industries. Whether the system is a complex air-traffic control system, manufacturing process control system, a reservation system, or a communication system, the ongoing management of the system is crucial to long-term success.

The nature of process control systems such as in communication packet or circuit switches involve the control of substantial hardware interfaces. These interfaces provide basic and advanced capabilities towards creating a comprehensive communications network for reliably transporting various types of data such as video media, voice traffic, or transactional data.

The communications industry provides features and functionality that combine essential reliable basic services along with specialized services and capabilities that are delivered through new technologies at varying stages of deployment and maturity. As communications systems are deployed, they often contain both traditional hardware interfaces along with new technology hardware interfaces that provides a basis for increased functionality or evolutionary incremental infrastructure that is meant to deliver more robust communications based on this expanded functionality or based on economic changes in technology.

Software programming that provides control logic to these communication systems is subject to increasing complexity. This complexity is driven by the newer technologies themselves such as voice over packet switching, new distributed hardware topologies, higher demanded bandwidths, or by reliability and management requirements such as better human interfaces, maintenance and diagnostic capabilities, or operational ease of management.

In communication systems for example, one necessary aspect of the operational management of the system is a capability to view the ongoing internal operations of the system. In a complex system, the internal operations of the system can contain large numbers of independent functional software tasks which process messages and events in connection with the operation of the system hardware interfaces.

Technical or business craft personnel are entrusted to manage the overall performance and health of a system. Management is typically accomplished via one or more human user interfaces that transforms the internal and external events and activities of the system into human readable text messages indicative of the behavior and performance of the system. These text messages provide information covering a wide range of system operations and convey the historical and present state of the system. Essential management decisions are often directly based upon these messages.

The style and effectiveness of the human interface is a reflection of the type of model employed by the system designers and architects and is often indicative of the basic philosophy of the interaction dialogue created to transform internal system activity into human recognizable operational behavior. In large process control systems, this dialogue can be composed of many thousands of text message elements.

These messages are typically developed in relation to the individual functional areas of the system. For example, there may be messages associated with historical performances, current operating system performance, individual hardware interface device types, external messaging statistics, internal messaging statistics, hardware faults, software faults, user informational messages, routing patterns, hardware usage statistics, system configuration, etc.

These messages are often a reflection of the individual philosophy of the architect or engineer(s) associated with a specific functional system area. Since the architect is often focused on a subset of the system, messages are typically created unique to that functional area of the system. For example, an engineer responsible for central processor unit (CPU) error processing tends to create messages unique to that specific area without regard to any universal system-wide message methodology. For very large systems, this partitioned creation of messaging tends to create inefficiencies in the overall structure of the system as a whole. Non-uniform message lengths, redundant messages, and inappropriate messages end up being distributed throughout the system software architecture. This dispersion can create inefficiencies.

One of these inefficiencies arises when passing these messages among the system tasks. Often, the entire text of a message is inserted within inter-task messages themselves. This can be wasteful in terms of CPU processing and memory utilization.

Text messages are usually encased in the local data area definitions associated with subsystems or specific tasks. This creates several potential problems including:

1) It creates a distributed message text database, instead of a central database. This may result in subtle (or even significant) differences in the message output due to difficulty in maintaining congruity in message meaning among tasks.

2) Localized databases are typically in scope to the software module creating it unless steps to make the message reference public are taken.

3) The memory allocation is also often allocated in the local memory space of the instantiating module.

4) The naming convention may be customized within a task so that the convention is known only within the specific task or module. This technique leads to the possibility of inadvertent duplicate messages existing across the system. This wastes memory space, which may be a significant issue in on-line real time systems.

5) Changes to the content of text messages may be more difficult to manage in a distributed messaging technique.

6) Efficient chaining of messages, i.e., building up of messages from primitive phrases may be less efficient overall.

7) Conveying of message text within the inter-task communication usually involves storing the entire message within the inter-task message, which inflates the amount of data in the inter-task message.

### SUMMARY OF THE INVENTION

It is therefore an object of the invention to provide a method and apparatus for centralizing message text strings within a computer controlled system.

It is another object of the invention to provide a method to efficiently pass message references known as a Text Reference Method (TRM) in an optimum manner within inter-task messages thus minimizing memory requirements and CPU processing.

It is yet another object of the invention to provide a means to provide a method of minimizing the amount of text memory in an overall system.

Further, it is yet another objective of the invention to provide a method of controlling text content and consistency.

Further, it is still another objective of the invention to eliminate text strings from being duplicated.

According to the invention there is a method of centralizing text messages within an exemplary embodiment of a communication system such as the Siemens Accession product. Inter-task messages are issued by controlling software tasks within the system in response to hardware or operational events of varying functions including requests from users or personnel responsible for overseeing the operation of the system. These inter-task messages may result in text messages eventually being displayed using the present invention. These text messages provide internal and external statuses, configuration, and operational performance of the system hardware and software.

As processing of normal and abnormal events within the communication system proceeds, software tasks within the system provide process control over the operation of the system. Hardware input and output interfaces provide access to the various unique operation of the system such as line interfaces, asynchronous transfer mode (ATM) controls, diagnostic and maintenance functions, power and operational status feedback, test access, and packet framing of voice and data. The hardware, under control of software specific tasks, produce software events that are managed by the system software as inter-task messages.

These inter-task messages initiate software task logic sequences associated with the originating hardware input. The software task may create another internal inter-task message to provide or initiate a feature or function as a result of the message. In many cases a task may generate an inter-task message which is meant to communicate an informational text message to human users of the system. These messages are generated for such reasons as hardware error conditions, hardware warnings, status updates, alarms, hardware configuration, software configuration readout of the system, internal states and conditions related to the system, traffic statistics, historical data, user initiated management of the system, etc.

Any inter-task messages that are generated to create a subsequent informational message to a person can be originated from essentially any task running within the system. An inter-task message is sent to a target task that is responsible for the direct interaction with a person viewing the informational messages on a display device such as a personal computer (PC), monitoring device, or equivalent such as a text to speech unit.

When a functional task initiates an inter-task message, which is destined to eventually produce an informational message, it is constructed employing a method of this present invention whereby the inter-task message bears a Text Reference. The Text Reference is an identification of a message contained in the central text message database. This reference is typically a 32-bit integer but could be any size of reference depending on the total message count of a system.

This 32-bit reference, known as a Message Look-up ID (MLU ID) is received by the User Interface task (UI) in the inter-task message and employed as a reference to the centralized message database. This method and apparatus allows all text messages to be controlled by one access method and lends itself to efficient arrangement of all text. Duplicate text strings within all messages are minimized as all messages can be reviewed and managed within one database. This eliminates the problem of inconsistent text strings. In terms of storage, the MLU ID is much more efficient to pass within an inter-task message as compared with text strings themselves.

The database containing the text messages can be ordered as one table or a collection of multiple tables arranged by function. In the case, the MLU ID contains within its definition an indicator that identifies which table is to be addressed.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is an exemplary block diagram of a communication system utilizing the present invention;

FIG. 2 is an exemplary block diagram of a software architecture contain tasks utilizing inter-task messaging within the system of FIG. 1;

FIG. 3 is an illustration of the Message Look-up Database Structure and Relationships;

FIG. 4A is an illustration of the TRM No Message Present Format;

FIG. 4B is an illustration of the TRM Message Look-up ID Format;

FIG. 4C is an illustration of the TRM Formatted String Pointer ID Format;

FIG. 4D is an illustration of the TRM Fault ID Format;

FIG. 5 is a flow diagram showing Text Reference Field Message Processing;

FIG. 6 is a flow diagram showing steps of creating TRM database tables; and

FIG. 7 is a flow diagram showing steps of using TRM.

### DETAILED DESCRIPTION OF A DETAILED EMBODIMENT OF THE INVENTION

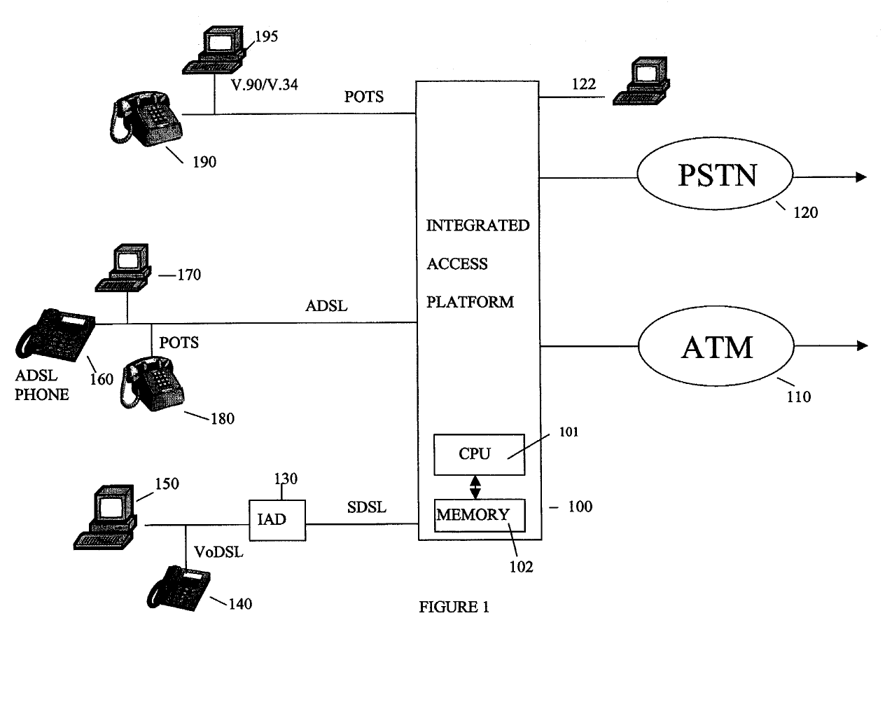

Referring to FIG. 1, an exemplary communication system is shown as an Integrated Access Platform (IAP), 100, which is a system to provide data and voice communications functionality. The IAP may be a modular system with various interface modules present to build a tailored system as required by a customer. The IAP provides the hardware and software functionality for subscribers to process and manage a wide range of communication features. The IAP contains a central processing unit (CPU), 101, and associated memory, 102, for implementing software programming and operating system. The system may contain more than one CPU and memory.

The IAP is connected, in this example, to an Asynchronous Transfer Mode (ATM) network and also to a Public Switch Telephone Network, 120. The IAP also provides interfaces of various kinds to subscribers and customers. Three examples of these interface types are illustrated.

At the bottom left, an IAP Symmetrical Digital Subscriber Line (SDSL) interface is connected to an Integrated Access Device (LAD), 130, which in turn supports a voice-over-digital subscriber line (VoDSL) phone, 140, and a data terminal, 150.

At the middle left, a asymmetric digital subscriber line (ADSL) interface connects a ADSL phone, 160, a data terminal, 170, and a plain old telephone service phone (POTS), 180, to the IAP.

At the top left, a POTS line connects a POTS phone, 190, and a V.90/V.34 data terminal, 195, to the IAP.

In a computer based process controlled system such as in a communication system, the ability to oversee and manage the operations of the system is essential. The User Interface to the system can be any of a number of device types such as a display, personal computer, or audio device. The User Interface, 122, is where a user can oversee the operations of the system and is where text is provided as messages in a session with the system.

The hardware components of a system can be of varying purposes and each component can in turn be controlled by its own computer processor complex, which may be in communication with other processor complexes (e.g., interface boards with CPU, memory, and software) throughout the system.

In a communications system or other process control systems, many functions of the system are performed by the hardware interfaces such as telephone interfaces, power interfaces, data and voice signaling interfaces, data and voice transport interfaces such as asynchronous transport mode (ATM), and support interfaces such as alarms and diagnostics. These interfaces have their own specific function in relation to the system as a whole. These interfaces are typically under control of software logic control running on one or more microprocessors. The system may contain redundant processor capability with one complex in standby mode. The processors include memory.

In a communications system the operating software typically includes a plurality of individual tasks. These tasks may run under the same or multiple processors. Each task is given time slices of the overall processor execution capacity typically under control of the operating system (OS) software. Each task is meant to contribute a particular control aspect on behalf of the system such as, for example, a user feature or a hardware diagnostic function. In order for the software system to operate in a collaborative fashion, these tasks are capable of creating inter-task messages to cause advancement of process control sequences. In the case of a communication system, the process control sequence, for example, could be the establishment of a call session between subscribers or recognize a request for call completion from the PSTN or ATM network.

In the course of typical operation, the hardware interfaces creates inputs to the software. The software generates event messages to represent the inputs of the hardware and thereafter controls the sequences of operations by passing inter-task messages to various system tasks responsible for progressing action of a specific type of message. Like-wise, a software task may cause a message to be created in response to a prior event that eventually causes a hardware component to provide a service such as, for example, tone generation in a voice path.

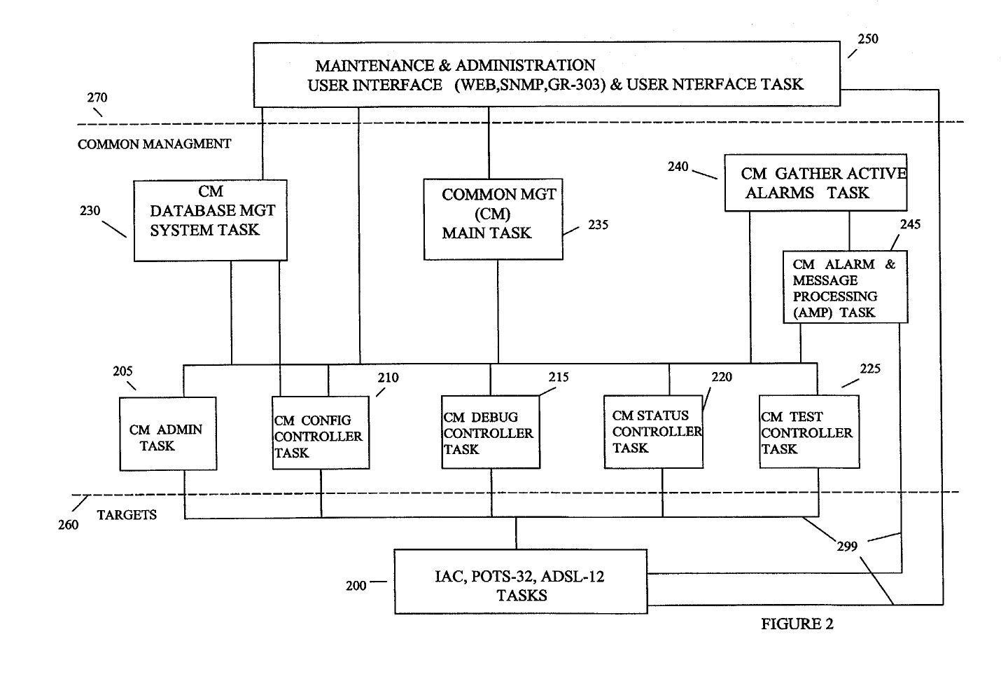

Referring now to FIG. 2, an exemplary software sub-system architecture suitable for a communication system is illustrated. This sub-system is one of several software sub-systems that may exist within a larger operating system (OS) context. This sub-system represents the Maintenance and Administration (M&A) sub-system of an IAP communication system. It provides the necessary controls and feedback to oversee and manage the overall operation of the system by people responsible for the ongoing performance of the system. It includes a User Interface Task, which receives requests and responds to requests over the user interface hardware such as a network interface port, RS-232 port or equivalent. This sub-system is the primary access for viewing the status and activity of the hardware components of the system and for configuring the system for optimum compliance to the desires of an operating company or other entity using an IAP.

This sub-system typically shares a processor with other sub-systems and is given access to the processor by an operating system such as VxWorks, or similar OS. The OS is also providing processor access to other sub-systems such as ATM Connection Control, Configuration Control, Processor Initialization, Narrowband Line Control, etc.

FIG. 2 is organized to show three distinct levels of functional control. At the bottom, delineated by dash line 260, are software target tasks, 200, responsible for directly controlling and monitoring specific hardware interfaces such as POTS, ADSL, and Integrated Access Controller (IAC). These tasks are capable of generating and receiving inter-task messaging represented by the solid lines, 299, which are bi-directional paths.

The Common Management (CM) layer, delineated between lines 260 and 270, include software tasks of a comprehensive maintenance and administration which control and interact with the target tasks, 200, and the M&A User Interface, 250, and with one another. The Common Management task, 235, distributes messages to proper CM layer tasks as necessary. Shown also in FIG. 2 are exemplary tasks CM Admin, 205, CM Config Controller, 210, CM Debug, 215, CM Status Controller, 220, CM Test Controller, 225, CM Database Management System, 230, CM Alarm & Message processing, 245, and CM Gather Active Alarms, 240.

CM Admin, 205, provides process control to administer system features as required by the system manager personnel through the M&A User interface, 250. CM Config, 210, provides system hardware configuration control as requested by the M & A User Interface. CM Debug Controller, 215, provides in-depth monitoring and feedback of detailed system information of system performance as requested by system managers. The CM Status Controller, 220, provides general status information of hardware and software elements and components via the M&A User Interface. CM Test Controller, 225, provides mechanisms to check and verify operational health of system components via the M&A User Interface. CM Active Alarms, 240, and CM Alarm Message Processing, 245, provide error and alarm detection and reporting control. CM Database Management system task, 230, controls access to and from the System Database in order to synchronize, isolate, and protect the system data.

Each of these tasks communicate with each other with an inter-task message (not shown) which is a common technique in real-time process control systems. An inter-task message may contain various informational and data elements as necessary to the nature of the message. For example, a diagnostic message bears diagnostic information associated with a hardware element; a call processing message bears information relevant to one or more ports, users, features dialed digits, etc.

Often tasks must communicate with human personnel through the M&A User Interface for a wide range of reasons including alarms, diagnostics, configuration, tests results, database contents, etc. In a sophisticated system, the total number of unique text messages that could be delivered for human viewing can be exceedingly large. This present invention provides a mechanism so that the control of the global content of these messages is more easily managed and reducing duplication. In addition, this present invention provides a mechanism so that actual memory requirement for defining actual text messages is considerably reduced overall. Also, in this present invention a Text Reference Method (TRM) replaces the text string within an inter-task message. This dramatically reduces memory requirements of the inter-task message, therefore increases throughput.

TRM is a centralized text system that eliminates the problems of inconsistent text strings, text strings being duplicated, additional space required for storage of static strings in the inter-task messages, and inefficient storage of text strings. There are two variations of this method. The “C” programming language is used to present examples below.

The TRM first method is used if a system requires that the text strings be grouped together by functional area, which prevents a huge text table from being generated. The second TRM variation is used for a system that has a small amount of text strings and growth is not anticipated or a direct reference method is required for a functional area.

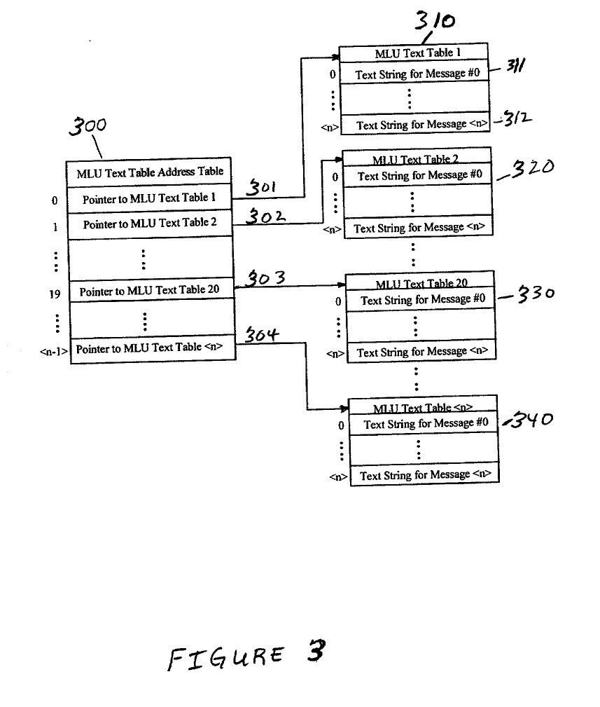

Referring to FIG. 3, for the first TRM variation, a set of database tables is used to store static text strings for a system. There are two types of tables, a Message Look-up Text Table Address Table (MLU TTAT), 300, and Message Look-up Text Tables (MLU TT) collectively shown as 310, 320, 330, and 340. There is typically only one MLU TTAT but multiple MLU TT. These tables are typically generated at compile time.

The Message Look-up Text Table Address Table, 300, contains the address of each Message Look-Up Text Table. Entry zero (zero-based numbering) of the MLU TTAT contains the address of the first MLU TT as shown by pointer, 301. The first entry points to the second MLU TT, 320, as shown by pointer 302. The nineteenth entry points to the twentieth MLU TT, 330, as shown by pointer 303. Finally, the last MLU TTAT entry points to the last table entry (n) of MLU TT, 340, as shown by pointer 304.

Each Message Look-up Table can contain a variable number of entries. The first MLU TT shows entry zero, 311 and the n^{th} entry, 312. These entries are typically fixed length text strings and generated at compile time.

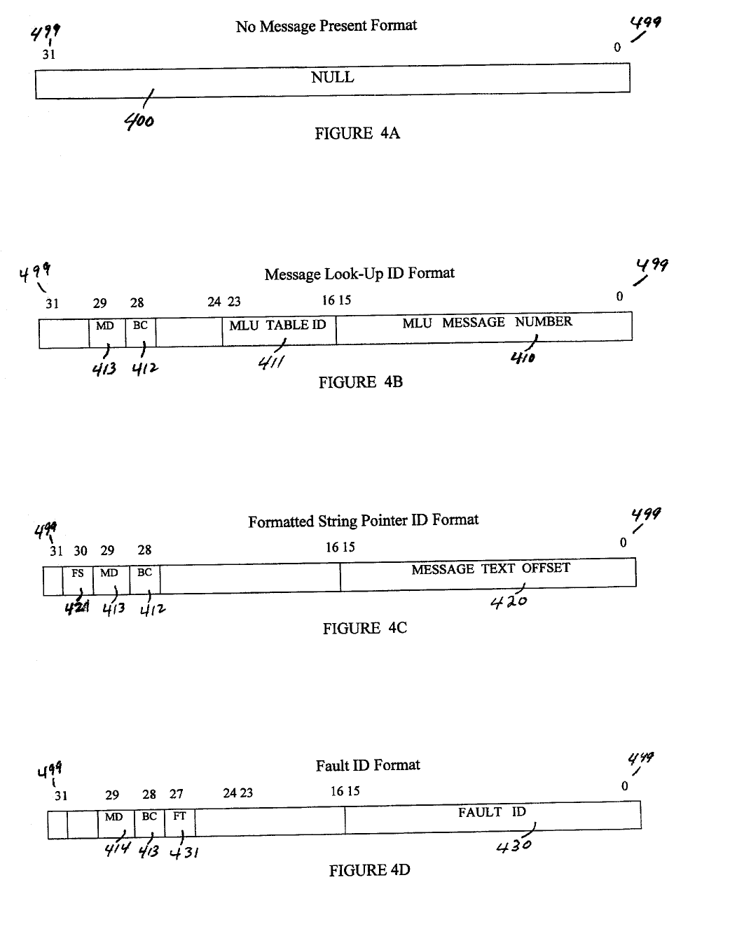

When a task creates an inter-task message and inserts a reference to a text string, a Text Reference Field (TRF) is used instead of the text string itself. A TRF is typically a single 32-bit integer per text message reference. It is possible to use a smaller or larger word such as 16-bit, 64-bit or 132-bit. This 32-bit integer has four different formats. These four formats are illustrated collectively in FIGS. 4A, 4B, 4C, 4D.

The first format is shown in FIG. 4A. This format is represented by a 32-bit integer value of zero (NULL), 400. This indicates no text message is present or being passed in the inter-task message. The formats are shown with bit positions 0-31, shown as 499.

The second format is shown in FIG. 4B. This format includes a MLU Table ID), 411, bits 16-23. This field is used as a first-level look-up index of the MLU Text Table Address Table, 300. This index provides a pointer to an appropriate MLU Text Table. The format also includes a MLU Message Number, 410, bits 0-15. This is a second-level index into the MLU Text Table indicated by the MLU Table ID, 411. This field is used to retrieve a null-terminated (or other sentinel terminated) text string from a particular Message Look-up Text Table such as 312 of FIG. 3.

A software routine such as mlu_query( ) can be used to retrieve a text string from a Message Look-up ID text reference field. The mlu_query( ) routine returns a boolean flag for success of failure and uses the following input parameters,

1) Message Look-up ID text reference field.

2) Pointer to a text string storage buffer.

3) Size of the text string storage buffer which can be implemented as a parameter or a global constant.

The following steps explains the operation of the mlu_query( ) routine,

1) Initialize the target text string buffer to all zeroes.

2) Get the MLU Table ID, 411, and MLU Message Number, 410, values from the TRF.

3) If the either the MLU Table ID or MLU Message Number is out-of-range, then return failure.

4) Create a pointer to the static text string by using the MLU Table ID to address MLU Text Table Address Table, 300, and also using Message Number values to index into the Message Look-up text tables, 310.

5) Copy the static text string to the string buffer up to the maximum byte size allowed.

6) Return success.

Common to three of the formats are Message Dump Flag (MD), 413, and Broadcast flag (BC), 412, as shown in FIGS. 4B, 4C, and 4D. When set, the MD indicates that an error has occurred and that the internal message data should be displayed to the user as debug information. When set, BC indicates that the referenced text string should be broadcast to all active users of the M&A User Interface.

The third format is shown in FIG. 4C. This format is driven when set, by the Formatted String Pointer ID flag (FS), 421, bit 30. This field indicates that the inter-task message contains an embedded formatted null-terminated (or other sentinel terminated) text string. This format includes a Message Text Offset, 420, bits 0-15. This offset, 420, defines the byte offset from the start of the inter-task message of where the formatted sentinel terminated text string is located within the inter-task message.

The Formatted String Pointer ID format is used within inter-task messages that need to convey information to a user that is only known during real-time operations or run-time. Formatted String Pointer IDs are created at run-time as needed. This format appends a formatted text string to the end of an inter-task message and formatted data is filled in as needed. The calculation of the Formatted String Pointer ID value and the appending of the text string can be performed by a common routine for example, fstr_create( ). This routine can be used to create a Formatted String Pointer ID text reference. fstr_create( ) routine returns a Boolean flag for success or failure and uses as input parameters,

1) Pointer to an inter-task message buffer.

2) Pointer to the location of the Formatted String Pointer ID text reference field within the message buffer.

3) Pointer to the formatted null-terminated (or other sentinel terminated) string.

4) Maximum byte size allocated for the inter-task message buffer.

The following steps explains the operation of the fstr_create( ) routine,

1) Get the length of the formatted null-terminated text string.

2) Get the current length of the inter-task message buffer (this requires that inter-task messages store a byte count field at a fixed or otherwise determinable location within the buffer).

3) If the current length of the message buffer plus the length of the text string exceeds the maximum byte size allocated, a failure is returned. Else, the routine appends the text string to the end of the message buffer.

4) The message text offset, 420, in the text reference field is set to indicate the starting location of the text message and the FS flag is set.

5) Update the byte count field of the message buffer to indicate the new overall size that includes the text string.

6) Return success.

Retrieval of the text string can be performed by a common routine for example, fstr_query( ). This routine is used to retrieve a text string from the Formatted String Pointer ID text reference field within an inter-task message. The fstr_query( ) routine returns a Boolean flag for success or failure and uses the following input parameters,

1) Pointer to the inter-task message buffer.

2) Formatted String Pointer ID text reference field.

3) Pointer to the text string storage buffer.

4) Size of the text string storage buffer (this can be implemented as an input parameter or as a global constant).

The following steps explains the operation of the fstr_query( ) routine,

1) Initialize the text string buffer to all zeroes.

2) If the FS flag is not set in the Formatted String Pointer ID text reference field, return failure.

3) Get the offset of the text string within the message from the text reference field.

4) If the offset exceeds the value of the byte count field in the message buffer, return failure.

5) Create a pointer to the formatted text string.

6) Copy the formatted text string to a string buffer up to an allowable size.

7) Return success.

The string buffer is subsequently processed which typically means sending to the M&A User interfaces.

The fourth format is a Fault ID format and is illustratively shown in FIG. 4D. This format uses the second TRM method a functional area requires a direct reference method. This format is driven when the Fault ID flag, 431, bit 27, is set. This format can be used within an inter-task message or can be used directly by the user interface to display a static text string to the user. The Fault ID is used within inter-task messages that need to convey information to users that is known only at run-time. Fault ID formats are created at run-time as needed. The Fault IDs used in the Fault ID format are typically assigned at compile time using standard C language #define values. The CREATE_FLT_ID( ) macro is used to create a fault ID. The retrieval of the text string is performed by the flt_query( ) routine.

The CREATE_FLT_ID( ) is used to create a Fault ID. The macro uses the following input parameters,

1) Address of a text reference field to place the generated Fault ID.

2) The offset (fault ID) of the desired text string in the Fault Text table, e.g., vg_static_flt_tbl[].

The following steps explains the operation of the CREATE_FLT_ID( ) macro,

1) The offset (fault ID) is placed in the Fault ID field, 430, of a text reference field.

2) The FT flag, 431, is set.

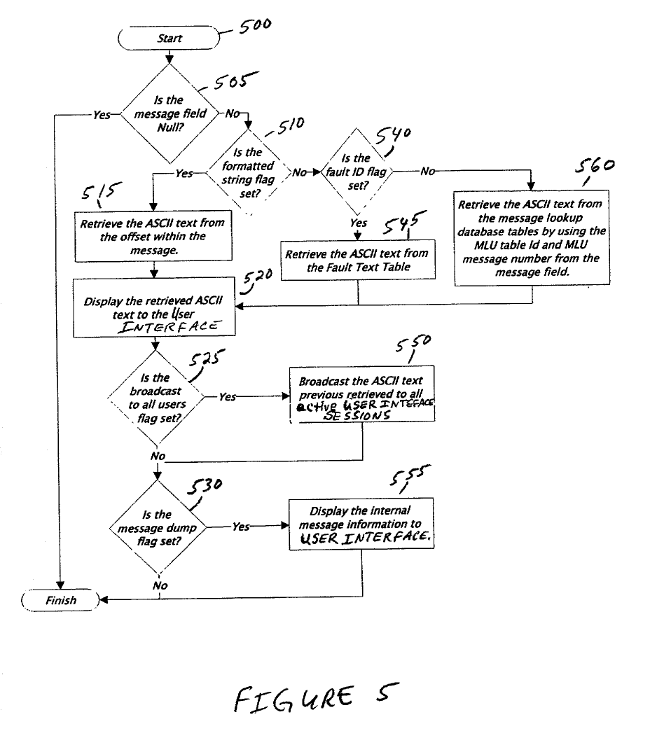

Referring additionally now to FIG. 5, this flow diagram describes the process that a User Interface task uses to receive, decode and process an inter-task message that contains a text reference field (TRF). The process begins at step 500 which pre-supposes reception of an inter-task message from a task within the communication system.

The first check is at step 505 to discover whether a message is present by checking for a null value. If the message field is null, the process is finished. If not null, a check is made to see if the formatted string flag (FS) 421 is set as shown in step 510. If FS is set, the inter-task message contains a Formatted String Pointer ID format. The ASCII text message is retrieved from the inter-task message using the message text offset, 420. The resulting text message is sent or output to a user display unit or equivalent such as a text-to-speech device, audio device, or a storage unit as shown at step 520.

If the FS flag is not set in step 510, another check is made to see if the TRF contains a fault ID by testing the fault ID flag (FT), 431, as shown at step 540. If the FT flag is set, an ASCII text string is retrieved using the fault ID index, 430, from a fault text table or other equivalent fixed text table as shown at step 545. The process then continues at step 520.

If however, the FT flag is not set at step 540, the TRF is a Message Look-up ID format. As shown by step 560, the MLU TTAT, 300, is accessed using the MLU Table ID, 411, to retrieve an address pointer to a MLU text table. The MLU Message number, 410, is then used to retrieve an actual text string from within the appropriate MLU text table such as 301, 320, 330, or 340 of the present exemplary embodiment. The process then continues at step 520, already described.

After step 520, a check is made of flag BC to discover whether this message should be broadcast to all active User Interface sessions, i.e., active users, as shown by step 525. If this flag is set, the text message is broadcast to all users as shown at step 550.

A final check is made as shown at step 530 whether the message dump flag (MD), 413, is set. If it is set, internal message dump information is displayed to the user as depicted at step 555. The process then awaits another inter-task message.

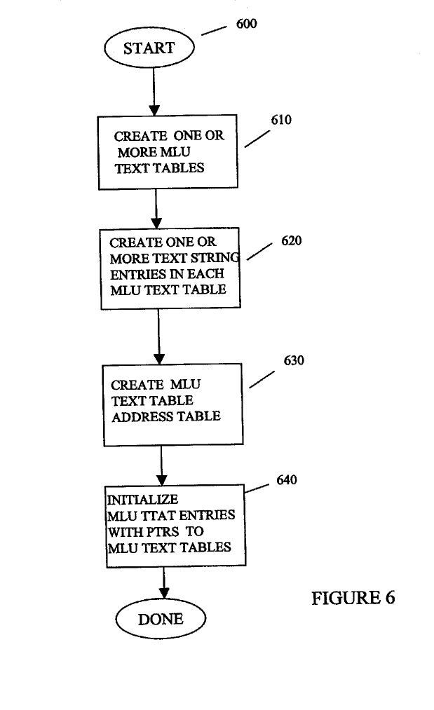

Referring now to FIG. 6, this flow diagram shows the steps in creating the MLU Text Tables (MLU TT) and the MLU Text Table Address Table (MLU TTAT). The flow shows the creation of two sets of tables that are created by a compilation. The process begins at 600. At step 610, one or more MLU Text Tables are created as necessary to contain the anticipated number of text messages. The allocation of the text strings between tables is normally related to the nature of the text table such as call processing text, maintenance text, configuration text, etc. However, one table may be used. At step 620, one or more text strings are created and assigned to a MLU Text Table entry. Each entry is typically null terminated. An associated #define is created for the text string mirroring the entry number within the table and the table number itself, which is used by any task as the TRF for the particular text string.

The method continues with step 630 where a MLU Text Table Address Table is created. This table contains as many entries as there are total number of MLU Text Tables. Every Text Table's address is assigned to an entry in the MLU TTAT. This is shown at step 640, whereby each entry is initialized with a pointer to the corresponding MLU Text Table. The order of assignment mirrors the ordinal sequence of the Text Table numbering scheme.

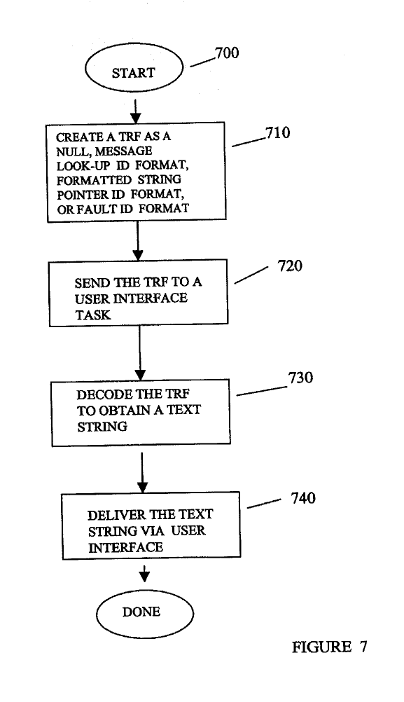

Referring to FIG. 7, the additional steps to use the Text Reference Method is illustrated which begins at step 700. At step 710, a task would create a TRF in one of the disclosed formats of FIG. 4A, 4B, 4C, or 4D. Next, as shown in step 720, the TRF is sent, typically in a inter-task message or similar manner, to a User Interface task. A User interface can be sent a TRF or use one directly. The TRF is decoded according to a format of FIG. 4 to obtain a text string as shown in step 730. As shown in step 740, the text string is then delivered via a user interface for display or other use.

While the invention has been described in terms of preferred embodiments, those skilled in the art will recognize that the invention can be practiced with modifications and in the spirit and scope of the appended claims.

Having thus described our invention, what we claim as new and desire by Letters Patent is as follows:

1. A method for organizing and accessing text messages within a computer based process control system having a User Interface to deliver text messages indicating any of internal and external statuses, configuration, and operational performance of the hardware and software, the method comprising the steps of:
creating one or more Message Look-up (MLU) Text Tables;
creating one or more text strings in each said one or more Message Look-up Text Tables;
creating a Message Look-up Text Table Address Table with total number of entries equal to at least the number of said Message Look-up Text Tables; and
initializing said Message Look-Up Text Table Address Table entries with pointers to each said one or more Message Look-up Text Tables.

2. The Text Reference Method as recited in claim 1, further comprising the steps of:
creating a Text Reference Field (TRF);
sending the TRF to a User Interface task;
decoding the TRF to obtain a text string; and
delivering the text string via the said User Interface.

3. The Text Reference Method as recited in claim 2, wherein said creating a Text Reference Field (TRF) step includes the step of creating a null TRF.

4. The Text Reference Method as recited in claim 2, wherein said creating a Text Reference Field (TRF) step includes the step of creating a Message Look-up Table ID and a Message Look-up Message Number.

5. The Text Reference Method as recited in claim 2, wherein said creating a Text Reference Field (TRF) step includes the step of creating a Message Text Offset and a Formatted String flag.

6. The Text Reference Method as recited in claim 2, wherein said creating a Text Reference Field (TRF) step includes the step of creating a Fault ID and Fault flag.

7. The Text Reference Method as recited in claim 2, wherein said decoding the TRF to obtain a text string step includes the step of checking the TRF for a null value.

8. The Text Reference Method as recited in claim 2, wherein said decoding the TRF to obtain a text string step includes the following steps:
checking the TRF for a set Formatted String Flag; and
retrieving the text string from within an inter-task message using a message text offset.

9. The Text Reference Method as recited in claim 2, wherein said decoding step includes the following steps:
checking whether a fault ID flag is set; and
retrieving the text string from a fault table using a fault ID within said TRF.

10. The Text Reference Method as recited in claim 2, wherein said decoding step includes the following steps:
retrieving from the TRF a Message Look-up Table ID;
accessing said Message Look-up Text Address Table using the Message Look-up Table ID as an index;
retrieving a pointer to a Message Look-up Text Table;
retrieving a MLU Message Number from said TRF; and
accessing said text string from said Message Look-up Text Table using a MLU Message Number as an index.

11. A processing system for organizing and accessing text messages by a computer based process control system, said computer based process control system having a User Interface to deliver text messages indicating any of internal and external statuses, configuration, and operational performance of the hardware and software, the processing apparatus comprising:
a first data structure in a memory of said computer based process control system, said first data structure including one or more tables of sentinel terminated text string entries;
a second data structure in said memory of said computer based process control system, said second data structure including one or more pointers to each of said one or more tables of said first data structure;
a means for creating a Text Reference Field;
a means for decoding said Text Reference field using said first and second data structures; and
a means for accessing said sentinel terminated text string entries and outputting said sentinel terminated text string entries via said User Interface.

12. An apparatus as recited in claim 11, wherein said User Interface comprises a display terminal.

13. An apparatus as recited in claim 11, wherein said User Interface comprises one of either a Text-to-speech device or audio device.

14. An apparatus as recited in claim 11, wherein said means for creating said Text Reference field includes a means for creating a Message Look-up ID format.

15. An apparatus as recited in claim 11, wherein said means for creating said Text Reference field includes a means for creating a Formatted String Pointer ID format.

16. An apparatus as recited in claim 11, wherein said means for creating said Text Reference field includes a means for creating a Fault ID format.

17. An apparatus as recited in claim 11, wherein said means for creating said Text Reference field includes a means for creating a No Message Present format.

18. A computer based process control system for organizing and accessing text messages, said computer based process control system having a User Interface to deliver text messages indicating internal and external statuses, configuration, and operational performance of the hardware and software, the system comprising:
a means for decoding a Text Reference Field(TRF) for a Formatted String (FS) flag;
a means for accessing a sentinel terminated text string within a message using a Message Text Offset within said TRF; and
a User Interface means for outputting said sentinel terminated text string.

19. A computer based process control system as recited in claim 18, wherein the means for decoding includes:
a means for testing for a Broadcast flag; and
a means for broadcasting said sentinel terminated text string to active User Interface sessions.

20. A computer based process control system as recited in claim 18, wherein the means or decoding includes:
a means for testing for a Message Dump flag; and
a means for displaying a message dump format to said User Interface.

21. A computer based process control system for organizing and accessing text messages, said computer based process control system having a User Interface to deliver text messages indicating any one of internal and external statuses, configuration, and operational performance of the hardware and software, the processing apparatus comprising:
a means for decoding a Text Reference Field(TRF) for a Message Look-up ID format;
a means for accessing a sentinel terminated text string using a Message Look-up ID and a Message Look-up Message Number contained in said Message Look-up ID format; and
a User Interface means for outputting said sentinel terminated text string.

22. A computer based process control system as recited in claim 21, wherein the means for decoding includes:
a means for testing for a Broadcast flag; and
a means for broadcasting said sentinel terminated text string to active User Interface sessions.

23. A computer based process control system for organizing and accessing text messages, said computer based process control system having a User Interface to deliver text messages indicating any one of internal and external statuses, configuration, and operational performance of the hardware and software, the processing apparatus comprising:
a means for decoding a Fault ID format within a TRF;
a means for accessing a sentinel terminated text string using a Fault ID field within said TRF; and
an User Interface means for outputting said sentinel terminated text string.

24. A computer based process control system as recited in claim 23, wherein the means for decoding includes:
a means for testing for a Broadcast flag; and
a means for broadcasting said sentinel terminated text string to active User Interface sessions.

25. A computer based process control system as recited in claim 23, wherein the means for decoding includes:
a means for testing for a Message Dump flag; and
a means for displaying a message dump format to said User Interface.
